(19) United States
(12) Patent Application Publication
(10) Pub. No.: US 2026/0292849 A1
(43) Pub. Date: Sep. 24, 2026

(54) METHODS FOR SYNCHRONIZATION SIGNAL TRANSMISSION ON UNLICENSED SPECTRUM

(71) Applicant: MediaTek Singapore Pte. Ltd., Singapore (SG)

(72) Inventors: Junqiang CHENG, Beijing (CN); Tao CHEN, Beijing (CN)

(21) Appl. No.: 19/165,962

(22) PCT Filed: May 11, 2024
(86) PCT No.: PCT/CN2024/092522

§ 371 Date: Sep. 16, 2025

(30) Foreign Application Priority Data
May 12, 2023 (WO) PCT/CN2023/093926

(51) Int. Cl. H04W 72/25; H04L 5/00; H04W 56/00; H04W 72/0453

(52) U.S. Cl. CPC H04W 72/25; H04L 5/0091; H04W 56/0015; H04W 72/0453

(57) ABSTRACT

In an aspect of the disclosure, a method, a computer-readable medium, and an apparatus are provided. The method may be performed by a UE. In certain configurations, the UE performs transmissions of a sidelink synchronization signal block (S-SSB) with repetitions in a plurality of resource block (RB) sets in a frequency domain on an unlicensed spectrum.

### CROSS-REFERENCE TO RELATED APPLICATION(S)

This PCT application claims the benefits of PCT Application Number PCT/CN2023/093926, entitled “METHODS FOR SYNCHRONIZATION SIGNAL TRANSMISSION ON UNLICENSED SPECTRUM” and filed on May 12, 2023, which is incorporated by reference herein in its entirety.

### TECHNICAL FIELD

The present disclosure relates generally to communication systems, and more particularly, to techniques of methods and apparatuses for synchronization signal transmission on unlicensed spectrum.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a UE. In certain configurations, the UE performs transmissions of a sidelink synchronization signal block (S-SSB) with repetitions in a plurality of resource block (RB) sets in a frequency domain on an unlicensed spectrum.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating SSB transmissions with repetition in frequency domain.

FIG. 8 is a diagram illustrating S-SSB RSRP fluctuation in the case of numbers of RB sets within a COT changes.

FIG. 9 is a diagram illustrating S-SSB repetition design of transmission number and location in multiple RB sets within one SL BWP.

FIG. 10 is a diagram illustrating S-SSB repetition design of transmission number and location in multiple RB sets within one SL BWP.

FIG. 11 is a diagram illustrating S-SSB repetition design of transmission number and location in multiple RB sets within one SL BWP.

FIG. 12 is a diagram illustrating S-SSB repetition design in multiple RB sets regarding to the relation of COT.

FIG. 13 is a flow chart of a method (process) for wireless communication of a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

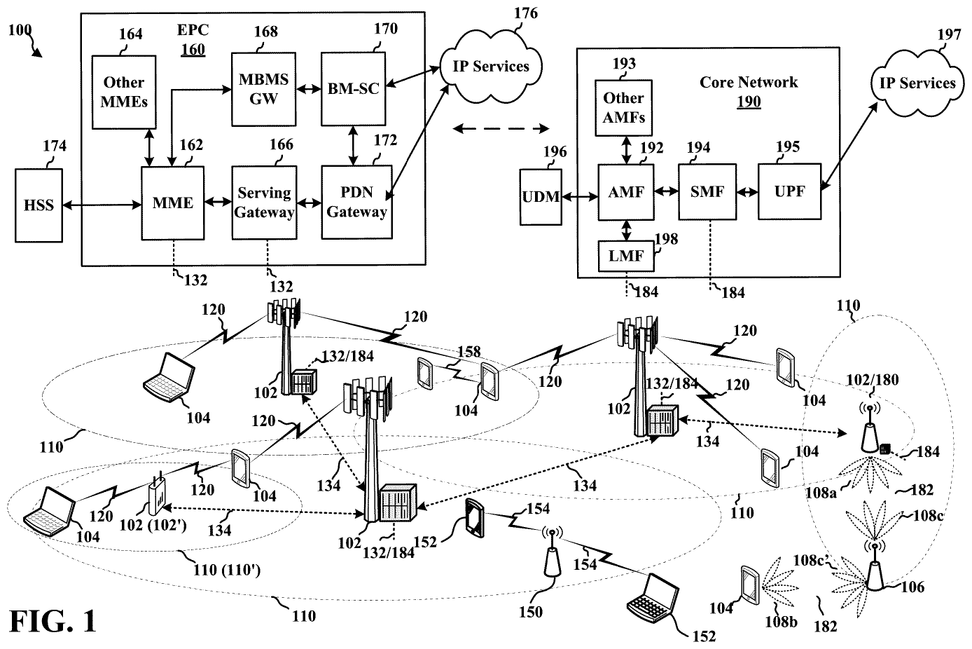

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

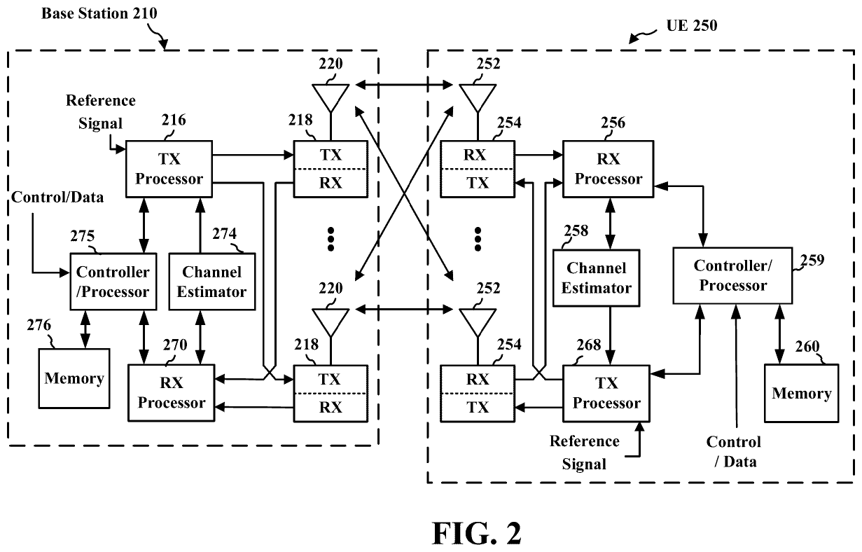

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

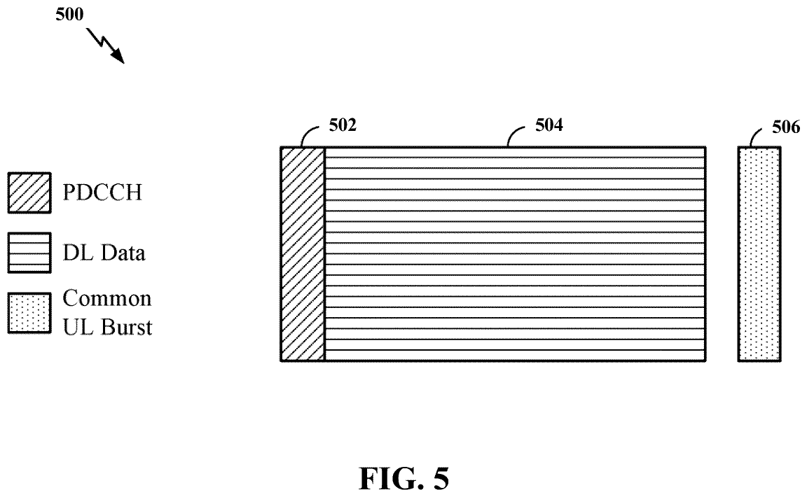

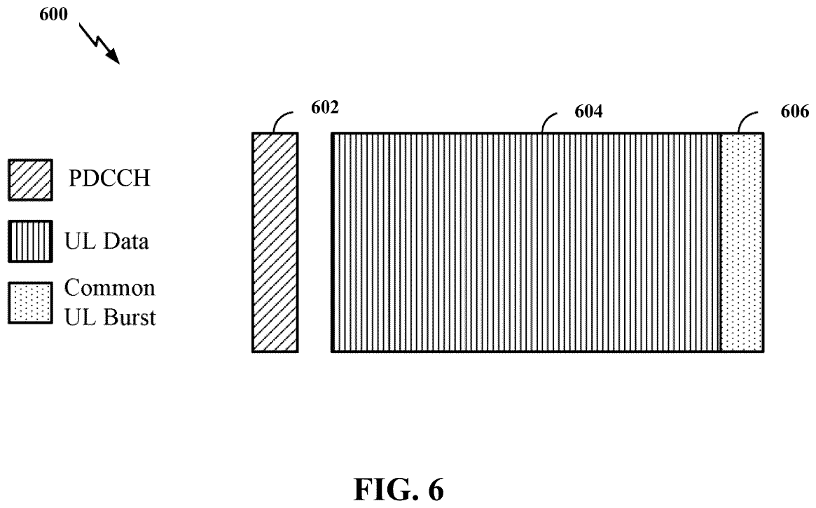

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

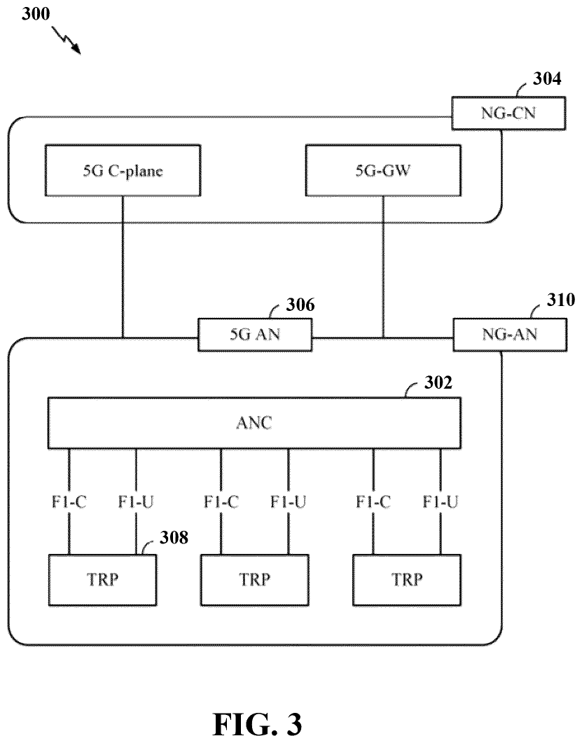

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

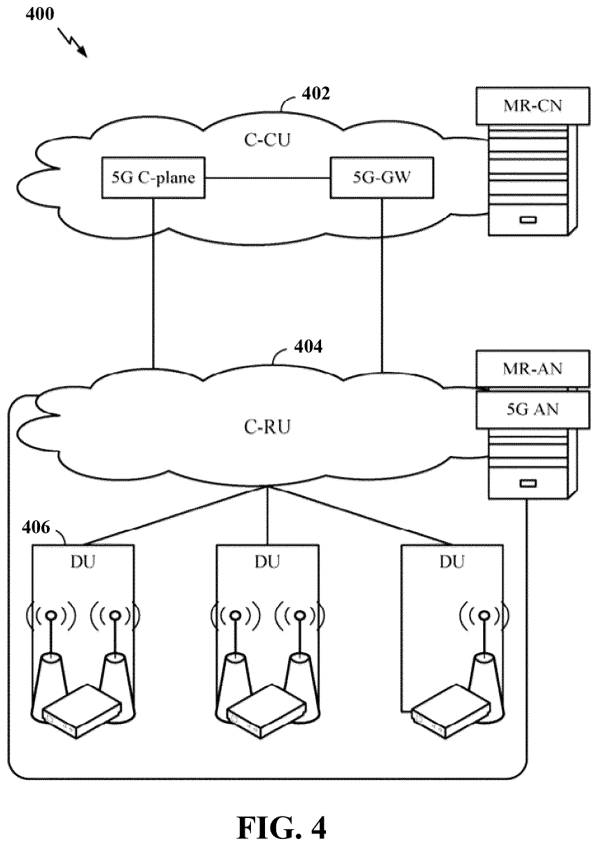

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

Occupied channel bandwidth (OCB) is a regulatory requirement for transmitting in unlicensed spectrum in some regions. If a 20 MHz Listen Before Talk (LBT) channel is occupied, the transmission needs to occupy at least 80% of the 20 MHz channel bandwidth. This ensures efficient usage of the unlicensed channel. OCB is calculated based on the lowest and highest subcarriers occupied within the channel. The gap between transmissions is not counted towards OCB. There is also a temporary exemption of the OCB requirement that allows minimum 2 MHz occupied bandwidth, but it is not recommended to rely on this exemption.

For sidelink (SL) transmissions over the unlicensed spectrum (SL over unlicensed spectrum, abbreviated as SL-U), considering that the SL synchronization signal (S-SSB, i.e., Special Subframe Configuration) only occupies 11 resource blocks (RBs) in the frequency domain, it cannot meet the OCB requirement and/or temporary exemption of OCB requirement for unlicensed spectrum. To address this issue, a method for S-SSB transmission in SL-U has been proposed to meet the OCB requirements and/or temporary exemption of OCB requirements for the unlicensed spectrum.

In certain configurations, for synchronization signal (e.g., S-SSB) transmission on unlicensed spectrum, it can be transmitted on multiple RB sets for the case than one BWP comprising multiple RB sets and/or one initiated channel occupancy time (COT) comprising multiple RB sets. Considering the OCB and power spectral density (PSD) limit over the unlicensed spectrum, the power of S-SSB (PSBCH/S-PSS/S-SSS) may be reduced when it is transmitted on multiple RB sets and results in a S-SSB/PSBCH power fluctuation/variance, which may further impact the RSRP based SyncRef selection mechanism of legacy SL. This issue needs to be addressed.

Aspects of the present disclosure relate to methods and designs for synchronization signal (e.g., S-SSB) transmissions on the unlicensed spectrum (e.g., SL-U). In one aspect of the disclosure, the S-SSB can be transmitted by SyncRef UE on one and/or multiple RB sets based on some factors. The factors can be the RB set number contained within one SL BWP and or the RB set number contained within one initiated COT. The number and location of S-SSB transmission in each RB set can be (pre-)configured and/or (pre-)defined. The transmission power of S-SSB can be determined based on the (max) PSD requirement on unlicensed spectrum, and/or based on the max transmission power limit by the UE capability, and/or a (pre-)configuration/(pre-)definition.

In another aspect of the disclosure, the Rx UE of S-SSB can be (pre-)configured and or by UE implementation to monitor the S-SSB(s) in multiple RB sets and/or the S-SSB(s) in one default RB set. The default RB set can be determined by the ARFCN. Additionally, the UE can be (pre-)configured and or by UE implementation to combine the detected S-SSB(s) or not.

This disclosure is motived by, but not limited to, a scenario where SL is transmitted on unlicensed spectrum (SL-U). In such scenario, the S-SSB can be transmitted on one RB set and/or multiple RB sets. Specifically, one case can be, when the SL-BWP contains multiple RB sets, and when UE attempts to transmit S-SSB in a S-SSB occasion (e.g., R16/17 S-SSB occasion, R18 additional candidate S-SSB occasion), the UE can be (pre-)configured and/or (pre-)defined to transmit S-SSB in one default RB set determined by ARFCN, and/or in more than one RB set (e.g., by the way of repetition) within the SL BWP. Additionally, another case can be, when an initiated COT contains multiple RB sets, and when UE attempts to transmit S-SSB in a S-SSB occasion (e.g., R16/17 S-SSB occasion, R18 additional candidate S-SSB occasion) within the initiated COT, the UE can be (pre-)configured to transmit S-SSB in one default RB set if it is included within the initiated COT, and/or in more than one RB set (e.g., by the way of repetition) within the initiated COT.

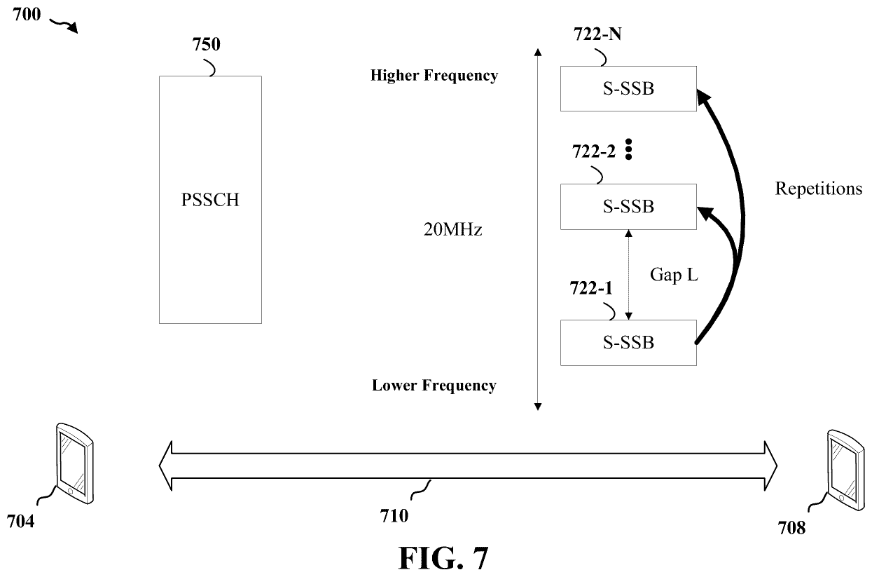

FIG. 7 is a diagram 700 illustrating SSB transmissions with repetition in frequency domain. As shown in FIG. 7, a UE 704 communicates with a UE 708 and/or other wireless devices on a sidelink 710 on an unlicensed spectrum. The UE 704 is configured to transmit SSBs 722-1, 722-2, . . . , 722-N simultaneously at different frequency locations on a frequency band. In this example, the frequency band has a bandwidth of 20 MHz.

Each of the SSBs 722-1, 722-2, . . . , 722-N are a copy of the same SSB. Therefore, the transmissions of the SSBs 722-1, 722-2, . . . , 722-N may be considered as transmissions of the SSB in repetition in frequency domain. The SSB may contain one or more of S-PSS/S-SSS/PSBCH.

The UE 704 may be (pre-)configured with the number of transmissions N and the gap L between two adjacent transmissions for transmitting the SSBs 722-1, 722-2, . . . , 722-N. The number of transmissions N indicates the number of S-SSB repetitions, and the gap L indicates the gap in frequency domain between adjacent S-SSBs. Using the SSBs 722-1, 722-2 as an example, this gap generally refers to the gap in the frequency domain between the highest subcarrier occupied by the SSB 722-1 and the lowest subcarrier occupied by the SSB 722-2.

The gap is in units of PRB (Physical Resource Block) or RB. For contiguous S-SSB repetitions, the gap is 0, and for non-consecutive S-SSB repetitions, the gap is greater than 0.

In certain configurations, all related parameters related to the number and locations of the S-SSB repetitions, including: the locations of the first S-SSB (e.g., starting point), the gap between two adjacent S-SSBs, the number of S-SSB repetitions, etc., can be (pre-)configured at the UE 704 and the UE 708. Further, the parameters may be signaled to the UE 704 and the UE 708 from a base station. Furthermore, the UE 704, after obtaining the parameters, may signal the parameters to the UE 708. In certain embodiments, the parameters can be carried on at least one of RRC (Radio Resource Control), MAC-CE (Medium Access Control-Control Element), the first SCI (Sidelink Control Information) and the second SCI, etc.

An RB set refers to a contiguous set of resource blocks (RBs) in the frequency domain. For example, in a 20 MHz system bandwidth with 15 kHz subcarrier spacing, there are a total of 100 RBs. This may be divided into two RB sets of 50 RBs each, with an intra-cell guard band in between. The S-SSBs are transmitted within an RB set.

The gap and number of transmissions N are configured per RB set. This allows different configurations in different RB sets if desired. The gap between repeated S-SSBs can be pre-configured per RB set, selected from the range of 0 to 84 PRBs. A gap of 0 PRBs indicates consecutive S-SSB transmissions with no gap. A gap greater than 0 PRBs indicates non-consecutive S-SSB transmissions with a gap in between. The number of S-SSB transmissions N can also be pre-configured per RB set, selected from the range of 2 to 9 transmissions.

The gap and N configurations allow flexibility in adjusting the S-SSB transmissions to meet the occupied channel bandwidth requirements for different subcarrier spacings and channel bandwidths. For a UE (e.g., the UE 704 and/or the UE 708) that supports NR sidelink communication in unlicensed spectrum (NR SL-U), the UE may indicate, by signaling, this capability of transmitting S-SSB repetitions within a plurality of RB sets. By signaling this capability, the UE indicates to the network that it is capable of transmitting repeated S-SSBs within the RB sets on the sidelink in unlicensed spectrum. Thus, the network can then configure the UE accordingly if it wants the UE to transmit repeated S-SSBs to meet the occupied channel bandwidth requirements.

In certain configurations, the number and location of the repetition of the S-SSB's transmitted in each RB set can be (pre-)configured and/or (pre-)defined based on a factor set. The factor set includes power/coverage requirement, OCB requirement, PSD requirement, size of SL BWP, size of initiated COT, occupied RB set property (e.g., one or multiple RB set(s), contiguous or non-contiguous RB sets) and sub-carrier spacing.

In certain configurations, when there is an initiated COT, the numbers of the RB sets within a COT may change. In this case, the maximum power for each COT may change, which may impact the legacy SL RSRP based SyncRef selection assuming there is a fixed max S-SSB transmission power.

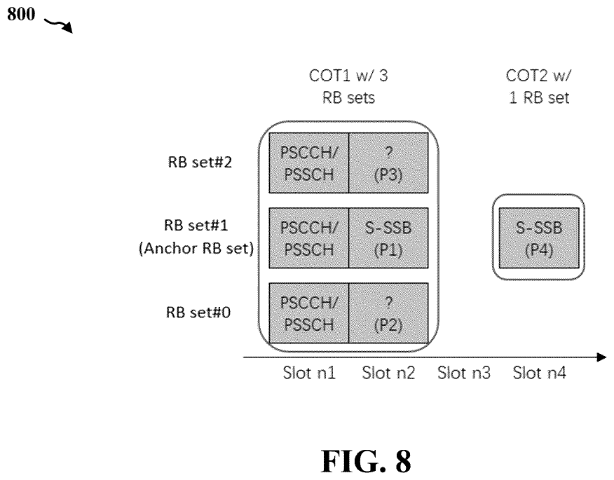

FIG. 8 is a diagram illustrating S-SSB RSRP fluctuation in the case of numbers of RB sets within a COT changes. As shown in FIG. 8, there are two COTs, including COT1 with 3 RB sets (RB set #0, #1 and #2) and COT2 with only 1 RB set (the anchor RB set #1). Regarding COT2, the maximum power P4 is 23 dBm in the slot n4. However, for COT 1, the maximum power P1=23 dBm−10*log(3), which is about 18 dBm in the slot n2. Assuming the maximum S-SSB transmission power is fixed, this may impact the legacy SL RSRP based SyncRef selection, and a method of power control is required when the transmissions of the S-SSB is across multiple RB sets.

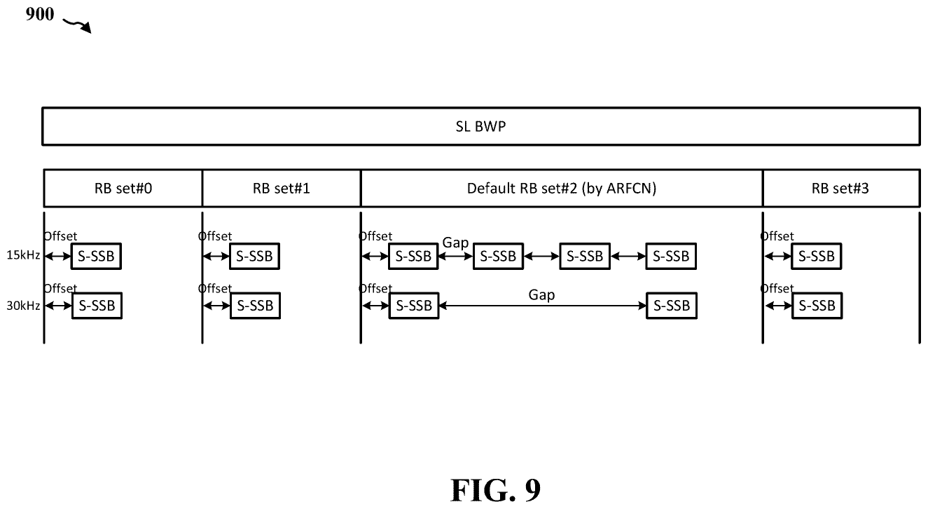

FIG. 9 is a diagram illustrating S-SSB repetition design of transmission number and location in multiple RB sets within one SL BWP. Specifically, FIG. 9 illustrates an exemplary S-SSB repetition design, in which one SL BWP includes 4 RB sets. Based on the ARFCN, the default S-SSB is in RB set #2 (i.e., default RB set). For the case of 15 kHz SCS, 4 S-SSB transmissions are (pre-)configured and/or (pre-)defined in the default RB set (i.e., RB set #2) with a gap between repetitions. The gap length L can be (pre-)configured to be 0 (i.e., contiguous S-SSB transmission) and/or other values based on the OCB requirement and S-SSB transmission number within an RB set. The number and location of the transmissions of the S-SSB with repetition in the RB set(s) other than the default RB set can also be (pre-)configured and/or (pre-)defined. For example, as shown in FIG. 9, for the other RB sets within the SL BWP, i.e., RB set #0, #1, and #3, one S-SSB is transmitted within each of the mentioned RB set, and the location of the S-SSB in each RB set other than the default RB set can be (pre-)configured and/or (pre-)defined by an offset from the boundary of the corresponding RB set.

In certain embodiments, the boundary of the corresponding RB set can be defined as the lower boundary of the corresponding RB set. For example, as shown in FIG. 9, the mentioned boundary refers to the lower boundaries (or the boundaries with lower frequency locations) of the RB set #0, #1 and #3. In certain embodiments, the boundary of the corresponding RB set can be defined as the higher boundary of the corresponding RB set. For example, the mentioned boundary may refer to the higher boundaries (or the boundaries with higher frequency locations) of the RB set #0, #1 and #3. Alternatively, in certain embodiments, the mentioned boundary can be defined as the boundary far from the default RB set. For example, for the RB set #3, the mentioned boundary may refer to the upper boundary (or the boundary with a higher frequency location) of RB set #3. For the RB set #0 and #1, the mentioned boundary may remain the lower boundaries (or the boundaries with lower frequency locations) of the RB set #0 and #1.

For another case of 30 kHz SCS as shown in FIGS. 9, 2 S-SSB transmissions are (pre-)configured and/or (pre-)defined in the default RB set with a gap between repetitions. The gap length L can be (pre-)configured to be 0 (i.e., contiguous S-SSB transmission) and/or other values based on the OCB requirement and S-SSB transmission number within the default RB set. For the other RB sets within the SL BWP, i.e., RB set #0, #1, and #3, one S-SSB is transmitted within each of the mentioned RB set. The location of each S-SSB in such RB set can be (pre-)configured and/or (pre-)defined by an offset from the boundary of the corresponding RB set. Additionally, the location of each S-SSB in such RB set can be (pre-)configured and/or (pre-)defined as same or different with the counterpart of 15 kHz SCS.

In certain embodiments, the transmissions of the S-SSB with repetitions are performed in the default RB set and at least one other non-default RB set within the SL BWP. Using FIG. 9 as an example, other than the default RB set #2, the S-SSB repetitions should exist in at least one of the RB set #0, #1 and #3.

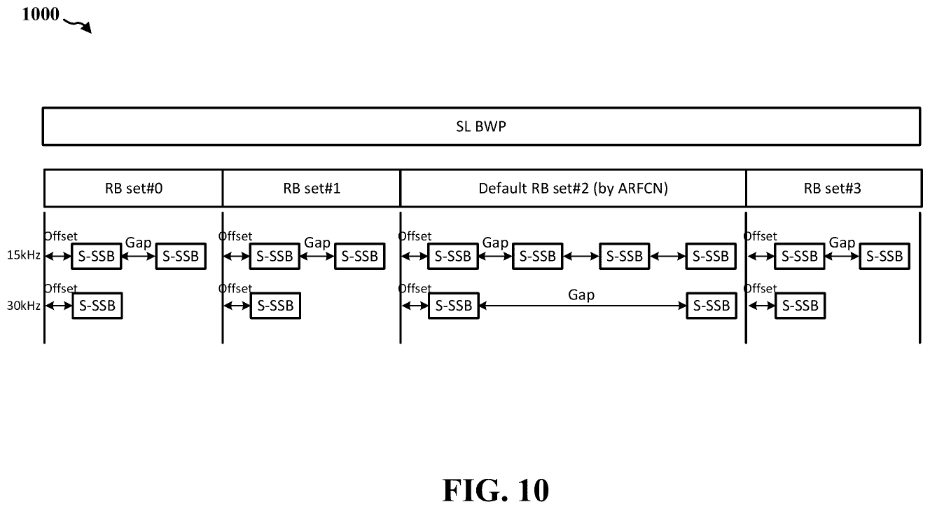

FIG. 10 is a diagram illustrating S-SSB repetition design of transmission number and location in multiple RB sets within one SL BWP. Specifically, FIG. 10 illustrates another exemplary S-SSB repetition design, in which the transmissions of the S-SSB with repetitions are performed in all RB sets within the SL BWP. As shown in FIG. 10, for the case of 15 kHz SCS, 4 S-SSBs are (pre-)configured and/or (pre-)defined in the default RB set (i.e., RB set #2) with a gap between repetitions. For the RB sets other than the default RB set, two S-SSB transmissions with offsets from the boundaries of the corresponding RB set are (pre-)configured and/or (pre-)defined. In this case, transmissions of the S-SSB with repetitions are performed in all 4 RB sets, but the number of the transmissions of the S-SSB in each RB set may be different. For the case of 30 kHz SCS, 2 S-SSB transmissions are (pre-)configured and/or (pre-)defined in the default RB set with a gap between repetitions. For the RB set(s)other than the default RB set, one S-SSB transmission with an offset from the boundary of the corresponding RB set is (pre-)configured and/or (pre-)defined.

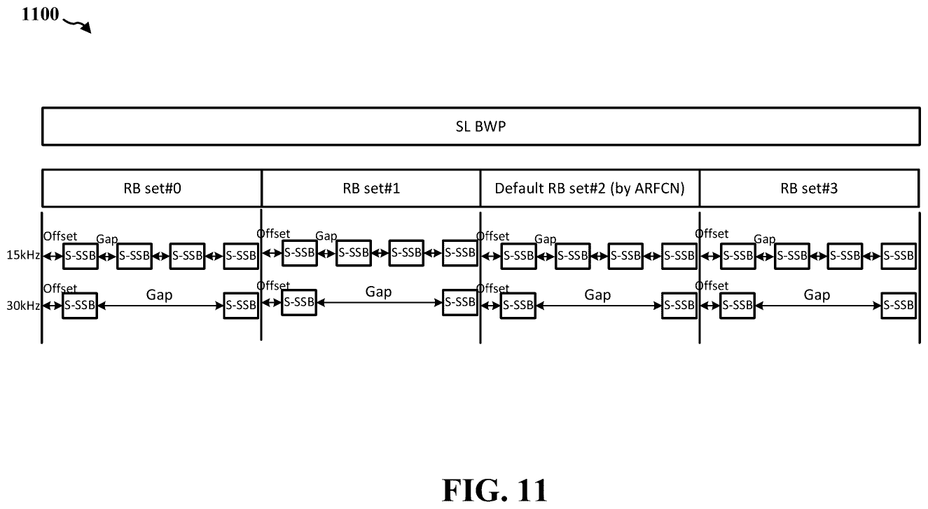

FIG. 11 is a diagram illustrating S-SSB repetition design of transmission number and location in multiple RB sets within one SL BWP. Specifically, FIG. 11 illustrates yet another exemplary S-SSB repetition design, in which the number and location of S-SSB transmission(s) within the default RB set is determined based on the OCB and PSD requirement. Then, the S-SSB transmission(s) on the other RB set(s) is a repetition of the S-SSB transmission(s) on the default RB set. As shown in FIG. 11, the S-SSB transmission(s) in default RB set #2 is determined firstly. For 15 kHz and 30 kHz SCS, it is 4 and 2 S-SSB transmissions within RB set #2, respectively. There is a (pre-)configured gap between S-SSB repetitions within the default RB set. The offset is (pre-)configured between the first/lowest S-SSB and the boundary with lower frequency location. Then, the S-SSB transmissions in other RB sets (i.e., RB set ##0, #1 and #3), is a repetition of the S-SSB transmissions in default RB set.

In certain configurations, the occupied channel BW of S-SSB transmission in the default RB set can be (pre-)configured as same or different based on the power calculation method for different SCSs. For example, for the case that the S-SSB transmission power is calculated by a PSD (e.g., the max PSD limit on unlicensed spectrum), the occupied channel BW of S-SSB transmission(s) in default RB set should be same for different SCS and/or the occupied channel BW of S-SSB transmission(s) in all RB set(s) within a SL BWP or a COT should be same for different SCSs. For the case the a (pre-)configured and/or a (pre-)defined power is used for S-SSB transmission, the occupied channel BW of S-SSB transmission in default RB set and/or all RB set(s) within a SL BWP or COT can be same and/or different for different SCSs. The (pre-)configured and/or (pre-)defined S-SSB transmission power can be based on a (linear) average over the S-SSB transmission number within occupied RB set(s), or the RB set within one SL BWP, or the RB set within an initiated COT, regarding to the max power limit of UE capability (e.g., 23 dBm). For example, 23 dBm for one RB set occupation, 20 dBm for two RB sets occupation, 17 dBm for four RB sets occupation, and 16 dBm for 5 RB sets occupation.

In certain configurations, the transmission power of S-SSB can be determined according to the occupied channel BW of S-SSB transmissions in multiple RB sets. The occupied channel BW means the total BW with S-SSB transmissions, and the potential guardband between S-SSB transmissions is not involved. One case is that the occupied channel BW of S-SSB(s) in multiple RB set(s) not greater than a threshold. The threshold can be (pre-)configured and/or (pre-)defined, e.g., 20 MHz. In this case, the max transmission power can be determined by an equal average of the S-SSB transmission number within the anchor RB set. Alternatively, the transmission power determination can be a PSD limit case. For example, the transmission power can be determined by the (max) PSD limit and the occupied BW of the S-SSB transmissions. For example, as shown by the case in FIG. 9, the transmission power of S-SSB is a PSD limit case. For 15 kHz SCS, the total S-SSB transmission power is 21.4 dBm, where 19 dBm in default RB set #2, and 13 dBm in each RB set other than the default RB set. For 30 kHz SCS, total S-SSB transmission power is 23 dBm, where 19 dBm in default RB set #2, and 16 dBm in each RB set other than the default RB set. Alternatively, another PSD limit case is shown in FIG. 10. For both 15 kHz and 30 kHz SCSs, the total S-SSB transmission power is 23 dBm, where 19 dBm in default RB set #2, and 16 dBm in each RB set other than the default RB set.

Additionally, another case is that the occupied channel BW of S-SSB transmission greater than a threshold (e.g., 20 MHz). In this case, the transmission power determination can be a power limit case and can be (pre-)configured and/or (pre-)defined based on some principle. The principle can be, for example, the max transmission power based on UE capability (e.g., 23 dBm) linearly averaged by the maximum S-SSB transmission number on RB set(s) within SL BWP regarding. As shown in FIG. 11, for both 15 and 30 kHz, the total transmission power is 23 dBm, and is 17 dBm of each RB set. Alternatively, the principle can be, a fixed power by (pre-)configuration/(pre-)definition. The fixed power can be determined by the max transmission power limit by the UE capability linear averaged by the max S-SSB transmission number on RB sets contained within one SL BWP. For example, the fixed power can be (pre-)configured/(pre-)defined as 16 dBm, which is determined by the 23 dBm linear average by 16 and 8 S-SSB transmissions within 5 RB sets for 15 and 30 kHz respectively. Then the actually total S-SSB transmission power can be determined by the fixed power of one RB set multiplying the occupied RB set number.

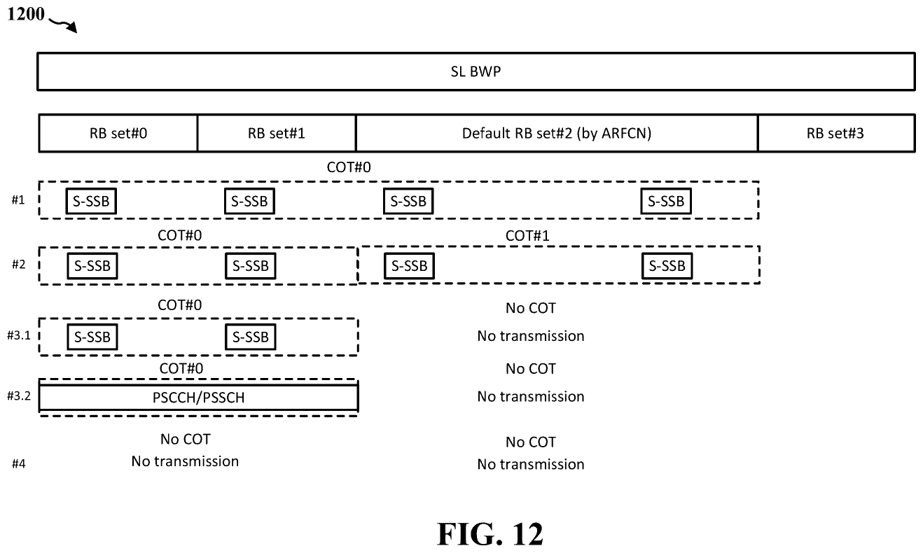

FIG. 12 is a diagram illustrating S-SSB repetition design in multiple RB sets regarding to the relation of COT. Specifically, FIG. 12 illustrates yet another exemplary S-SSB repetition design, in which the transmissions of the S-SSB with repetitions are performed in all RB sets within an initiated COT. In certain configurations, when SL BWP contains multiple RB sets, and SynRef UE attempts to transmit S-SSB in a S-SSB occasion (e.g., R16/17 S-SSB occasion, R18 additional candidate S-SSB occasion), it can transmit S-SSB repetitions in more than one RB set or all RB set(s) within SL BWP based on some principles. The principle can be, for example, there is an initiated COT overlapping with the S-SSB occasion(s) in time domain. In frequency domain, the initiated COT contains multiple RB sets, where the default RB set is included or not. As shown in FIG. 12, for case #1, the initiate COT (i.e., COT #0) contains 3 RB sets, where the default RB set (i.e., RB set #2) is included. In this case, the S-SSB repetition is transmitted in each RB set within the initiated COT. For case #2, the initiated COT (i.e., COT #0) contains two RB sets of RB set #0 and #1. The default RB set is included in another COT (i.e., COT #1). In this case, S-SSB repetition is transmitted in each RB set of both COT #0 and #1. In cases #3.1 and #3.2, the initiated COT (i.e., COT #0) contains two RB sets of RB set #0 and #1. The default RB set is not included by any COT. In this case, S-SSB repetition (i.e., case #3.1) and/or PSCCH/PSSCH transmission (i.e., case 3.2) is transmitted in COT #0. In case #4, there in no initiated COT on S-SSB occasion, and thus there is no S-SSB transmission on each RB set.

In another aspect of the disclosure, from the perspective of Rx UE (e.g., the UE 708 as shown in FIG. 7), it can be (pre-)configured and/or (pre-)defined to monitor/detect only the default S-SSB RB set (determined by ARFCN), and/or each RB set within a SL BWP. Additionally, the Rx UE (e.g., the UE 708) can be (pre-)configured and/or (pre-)defined to combine all or partial monitored/detected S-SSB(s) in the default RB set, and/or to combine all or partial monitored/detected S-SSB(s) in all RB set(s) within a SL BWP, and/or only decode one S-SSB (determined by ARFCH) in default RB set, and/or combine one S-SSB in each RB set within a SL BWP.

In another aspect of the disclosure, to combat the potential LBT failure when the UE accesses the channel, some resource allocation enhancements can be used. For example, for a UE reserving resource(s), it can overbook some resource(s) and indicate the overbooking information in the SCI (e.g., 1st SCI and/or 2nd SCI). In certain embodiments, for example, the UE can overbook N (consecutive) resource before its reserved resource (with a high priority). In one embodiment, the value of N can be determined by the UE from a set. The set can be determined by LBT information, contention window size, random back-off counter value, and channel busy ratio, traffic priority. For example, the set can be determined as {0,1}. In certain embodiments, the value of N can be indicated by the UE reserving resource via SCI (e.g., 1st SCI and/or 2nd SCI). Alternatively, for the UE(s) other than the UE reserving a resource, it can avoid select of N (consecutive) resource before the reserved resource (with high priority). The value of N is (pre-)configured from a set. The set can be (pre-)configured as, for example, {0,1} or {0,1,2,3}, or {1,2}.

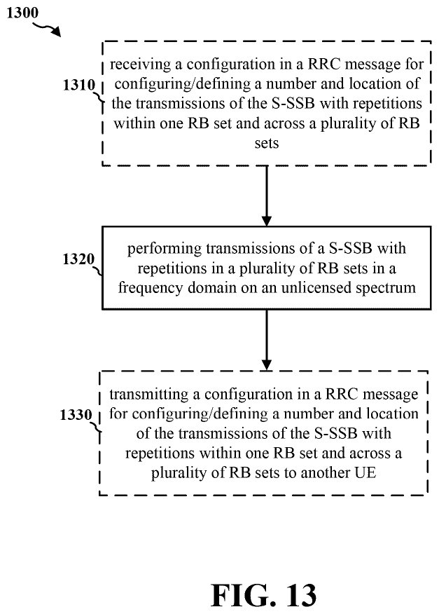

FIG. 13 is a flow chart of a method (process) for wireless communication of a UE. The method may be performed by a UE (e.g., UE 704 and/or UE 708). At operation 1310, optionally, the UE receives, either from a base station or from another UE, a configuration in a RRC message for configuring/defining a number and location of the transmissions of the S-SSB with repetitions within one RB set and across a plurality of RB sets. At operation 1320, the UE performs transmissions of a S-SSB with repetitions in a plurality of RB sets in a frequency domain on an unlicensed spectrum. At operation 1330, optionally, the UE may transmit a configuration in a RRC message for configuring/defining a number and location of the transmissions of the S-SSB with repetitions within one RB set and across a plurality of RB sets to another UE, in order to configure the receiving UE. In certain embodiments, the configuration transmitted at operation 1330 may be the same with the configuration received at operation 1310.

In certain embodiments, the transmissions of the S-SSB with repetitions are performed in one default RB set and at least one other non-default RB set within a SL BWP. In one embodiment, the default RB set is an RB set including the S-SSB determined by an ARFCN.

In certain embodiments, the transmissions of the S-SSB with repetitions are performed in all RB sets within a SL BWP.

In certain embodiments, the transmissions of the s-ssb with repetitions are performed in all RB sets within an initiated COT.

In certain embodiments, a number and location of the transmissions of the S-SSB with repetitions within one RB set and across the plurality of RB sets are configured or defined based on a factor set. In one embodiment, the factor set includes: power and/or coverage requirement, occupied channel bandwidth (OCB) requirement, power spectral density (PSD) requirement, a size of a sidelink (SL) bandwidth part (BWP), a size of channel occupancy time (COT), occupied RB set property, and sub-carrier spacing.

In certain embodiments, a radio research control (RRC) parameter is provided defining an offset between a lowest S-SSB and a lower boundary of one RB set.

In certain embodiments, the UE may further determine whether the valid measurement for the target cell related to the RRM procedure has been performed within the predetermined period of time before receiving the triggering command. in response to determining the valid measurement has not been performed within the predetermined period of time, the UE may determine the target cell as an unknown target cell. Then, the UE may perform the RRM procedure for the unknown target cell.

In certain embodiments, a S-SSB transmission power is determined based on the transmission channel BW of all of the transmissions of the S-SSB. In one embodiment, for the transmission channel BW of all of the transmissions of the S-SSB not larger than 20 MHz, the S-SSB transmission power is determined by an equal average over a number of the S-SSB transmissions on default RB sets regarding to the max power limit of UE capability. In one embodiment, for the transmission channel BW of all of the transmissions of the S-SSB larger than 20 MHz, the S-SSB transmission power is determined by an equal average over a maximum number of the S-SSB transmission on RB sets within the SL-BWP regarding to the max power limit of UE capability, or the S-SSB transmission power of is configured or defined as a fixed value per RB set.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
performing transmissions of a sidelink synchronization signal block (S-SSB) with repetitions in a plurality of resource block (RB) sets in a frequency domain on an unlicensed spectrum.

2. The method of claim 1, wherein the transmissions of the S-SSB with repetitions are performed in at least one default RB set at one S-SSB occasion.

3. The method of claim 2, wherein the default RB set is an RB set including the S-SSB determined by an absolute radio-frequency channel number (ARFCN).

4. The method of claim 1, wherein the transmissions of the S-SSB with repetitions are performed in all RB sets within a sidelink (SL) bandwidth part (BWP).

5. The method of claim 1, wherein the transmissions of the S-SSB with repetitions are performed in all RB sets within an initiated channel occupancy time (COT).

6. The method of claim 1, wherein a number and location of the transmissions of the S-SSB with repetitions within one RB set and across the plurality of RB sets are configured or defined based on a factor set.

7. The method of claim 6, wherein the factor set includes:
power and/or coverage requirement,
occupied channel bandwidth (OCB) requirement,
power spectral density (PSD) requirement,
a size of a sidelink (SL) bandwidth part (BWP),
a size of channel occupancy time (COT),
occupied RB set property, and
sub-carrier spacing.

8. The method of claim 1, wherein a radio research control (RRC) parameter is provided defining an offset between a lowest S-SSB and a lower boundary of one RB set.

9. The method of claim 1, wherein a S-SSB transmission power is determined based on a transmission channel bandwidth (BW) of all of the transmissions of the S-SSB at one S-SSB occasion.

10. The method of claim 9, wherein for the transmission channel BW of all of the transmissions of the S-SSB not larger than 20 MHz, the S-SSB transmission power is determined by an equal average over a number of the S-SSB transmissions on default RB sets regarding to the max power limit of UE capability.

11. The method of claim 9, wherein for the transmission channel BW of all of the transmissions of the S-SSB larger than 20 MHz, the S-SSB transmission power is determined by an equal average over a maximum number of the S-SSB transmissions on RB sets within the SL-BWP regarding to the max power limit of UE capability, or the S-SSB transmission power of is configured or defined as a fixed value per RB set.

12. An apparatus for wireless communication, the apparatus being a user equipment (UE), comprising:
a memory; and
at least one processor coupled to the memory and configured to:
perform transmissions of a sidelink synchronization signal block (S-SSB) with repetitions in a plurality of resource block (RB) sets in a frequency domain on an unlicensed spectrum.

13. The apparatus of claim 12, wherein the transmissions of the S-SSB with repetitions are performed in at least one default RB set at one S-SSB occasion.

14. The apparatus of claim 13, wherein the default RB set is an RB set including the S-SSB determined by an absolute radio-frequency channel number (ARFCN).

15. The apparatus of claim 12, wherein the transmissions of the S-SSB with repetitions are performed in all RB sets within a sidelink (SL) bandwidth part (BWP).

16. The apparatus of claim 12, wherein the transmissions of the S-SSB with repetitions are performed in all RB sets within an initiated channel occupancy time (COT).

17. The apparatus of claim 12, wherein a radio research control (RRC) parameter is provided defining an offset between a lowest S-SSB and a lower boundary of one RB set.

18. The apparatus of claim 12, wherein a S-SSB transmission power is determined based on a transmission channel bandwidth (BW) of all of the transmissions of the S-SSB.

19. The apparatus of claim 18, wherein for the transmission channel BW of all of the transmissions of the S-SSB not larger than 20 MHz, the S-SSB transmission power is determined by an equal average over a number of the S-SSB transmissions on default RB sets regarding to the max power limit of UE capability.

20. The apparatus of claim 18, wherein for the transmission channel BW of all of the transmissions of the S-SSB larger than 20 MHz, the S-SSB transmission power is determined by an equal average over a maximum number of the S-SSB transmission on RB sets within the SL-BWP regarding to the max power limit of UE capability, or the S-SSB transmission power of is configured or defined as a fixed value per RB set.
